(19) United States
(12) Patent Application Publication
(10) Pub. No.: US 2025/0060267 A1
(43) Pub. Date: Feb. 20, 2025

(54) SYSTEMS, METHODS, AND INTERFACES FOR VIEWING, MAINTAINING, AND INSPECTING PRESSURIZED FLUID TANKS

(71) Applicant: APPLIED PHYSICS, LLC, Pocatello, ID (US)

(72) Inventors: DANIEL SNELL, 2975 CLEARWATER ST, ID (US); MICHAEL R. JAGLOWSKI, POCATELLO, ID (US)

(21) Appl. No.: 18/235,287

(22) Filed: Aug. 17, 2023

(51) Int. Cl. G01L 19/08; G01L 19/12; H04Q 9/00

(52) U.S. Cl. CPC G01L 19/083; G01L 19/086; G01L 19/12; H04Q 9/00

(57) ABSTRACT

A pressurized fluid tank monitoring device configured to provide notice regarding pressurized fluid data of a pressurized fluid inside a pressurized fluid tank can comprise a pressurized fluid tank, a computer system communicably attached to the pressurized fluid tank, the computer system having (i) a processing module; (ii) one or more digital sensors; and (iii) one or more managing components. The pressurized fluid tank monitoring device can further comprise a display communicably connected to the computer system, the display having one or more LED light sources. The computer system, in turn, can be configured to retrieve and process pressurize fluid data from one or more digital sensors to determine current pressurized fluid data of the pressurized fluid inside the pressurized fluid tank. The computer system can also illuminate the display according to the determined pressurized fluid data.

### BACKGROUND

### 1. Technical Field

Embodiments described herein relate to pressurized fluid tanks.

### 2. Background and Relevant Art

Pressurized fluid tanks (e.g., air tanks) play a vital role in the medical field, primarily serving as a critical component in patient care for those with breathing-related issues. They are commonly used in hospitals, healthcare facilities, and home healthcare to deliver supplemental oxygen to patients suffering from conditions like pneumonia and other respiratory disorders that impede the body's ability to absorb oxygen efficiently. Medical pressurized fluid tanks work by storing a fluid, such as oxygen, under high pressure, typically in a cylindrical or rectangular container, and releasing it through a regulator that controls the flow rate according to the patient's needs. In critical care settings such as intensive care units, pressurized fluid tanks may routinely be used to help stabilize patients' oxygen levels. Portable versions of these tanks have made it possible for doctors to transport patients throughout the hospital according to the patients' needs.

In the world of scuba diving, pressurized fluid tanks (i.e., scuba tanks or cylinders) may serve a similar and equally important purpose. They may provide divers with the necessary oxygen to breathe underwater for extended periods. The tanks may be made of steel or aluminum and may hold air that has been pressurized to levels that could range from 2000 psi to 3500 psi. The stored air is delivered to the diver through a regulator, which reduces the high pressure in the tank to an ambient pressure that the diver can comfortably breathe.

Despite their distinct applications, the use of pressurized fluid tanks in both medical and scuba diving contexts may require careful monitoring and maintenance to ensure safety. In the medical field, tanks may be regularly inspected to manage the amount of oxygen remaining in the tank in order to avoid emergency situations. Similarly, in scuba diving, divers may be trained to monitor their air supply and manage their consumption rate to prevent running out of air underwater.

Traditionally, both divers and medical professionals have relied on a simple pressure gauge mounted to the container to deduce the remaining capacity of the tank. However, traditional pressure gauges can make inspecting and maintaining any given tank, much worse a fleet of pressurized fluid tanks, challenging at least in part as such monitoring may require individual tank inspection. In cloudy or dark conditions, such as an in emergent or underwater condition, the inability to clearly see or appreciate a tank's actual capacity for providing oxygen can prove fatal.

Accordingly, there are a number of difficulties in the art that can be addressed.

### BRIEF SUMMARY

The present invention provides systems, methods, and computer program products related to monitoring one or more pressurized fluid tanks, and providing clear, real-time, immediately understandably notifications of status, such as oxygen capacity. In at least one implementation, a pressurized fluid tank monitoring device or system provides accurate, real-time, and visual notice regarding pressurized fluid data of a pressurized fluid in a pressurized fluid tank, such as through one or more visible indicators, such as one or more light sources. The disclosed visual indicators provide significant advantages to efficiency, and predictability of pressurized fluid tanks, as they can allow for a much simpler and faster way to ascertain the status of a pressurized fluid in a pressurized fluid tank.

Along these lines, a pressurized fluid tank monitoring device can be configured to provide notice regarding pressurized fluid data of a pressurized fluid inside a pressurized fluid tank can include a pressurized fluid tank. The pressurized fluid tank monitoring device can also include a computer system communicably attached to the pressurized fluid tank, the computer system having (i) a processing module; (ii) one or more digital sensors; and (iii) one or more managing components. The pressurized fluid tank monitoring device can further include a display communicably connected to the computer system, the display having one or more LED light sources. The computer system, in turn, can be configured to retrieve and process pressurize fluid data from one or more digital sensors to determine current pressurized fluid data of the pressurized fluid inside the pressurized fluid tank. The computer system can also illuminate the display according to the determined pressurized fluid data.

As another example, a system for monitoring a plurality of pressurized fluid tanks through a network can include a central server communicably connected over a network to one or more pressurized fluid tanks. Each pressurized fluid tank, in turn, can include a computer system communicably attached to its corresponding pressurized fluid tank, the computer system having (i) a processing module; (ii) one or more digital sensors; and (iii) and a managing component. The system can further include a display communicably connected to the computer system, the display having one or more LED light sources. Each pressurized fluid tank, in turn, is configured, through its attached computer system, to retrieve and process pressurize fluid data from one or more digital sensors to determine current pressurized fluid data of the pressurize fluid inside the pressurized fluid tank. Each pressurized fluid tank in turn is also configured to illuminate the display according to the determined pressurized fluid data. The central server, in turn, is configured to illuminate a central server display according to the pressurized fluid data for each pressurized fluid tank in the network.

As yet another example, a computer-implemented method for maintaining a real-time display of pressurized fluid data of pressurized fluid inside a pressurized fluid tank can include retrieving pressurized fluid data of the pressurized fluid from one or more digital sensors communicably coupled with a pressured tank. The method can further include processing the retrieved pressurized fluid data to determine a first color that is associated with the retrieved pressurized fluid data. The method can also include displaying on a digital display attached to the pressurized fluid tank the determined first color. The method can further include displaying on the digital display a second color that is different from the first color upon receipt of a change in pressurized fluid data.

Additional features and advantages will be set forth in the description which follows, and in part will be obvious from the description, or may be learned by practice. The features and advantages may be realized and obtained by means of the instruments and combinations particularly pointed out in the appended claims and aspects. These and other features will become more fully apparent from the following description and appended claims or may be learned by the practice of the examples as set forth hereinafter.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, embodiments described herein will be described and explained with additional specificity and detail through the use of the accompanying drawings in which:

FIG. 1 illustrates a schematic of a pressurized fluid tank monitoring device in accordance with one embodiment described herein;

FIG. 2 illustrates a schematic of a central server in accordance with one embodiment described herein;

FIG. 3 illustrates a system that includes a pressurized fluid tank monitoring device and a central server in accordance with one embodiment described herein;

FIG. 4 illustrates a schematic of an interaction between a central server and one or more pressurized fluid tank monitoring device clients in accordance with one embodiment described herein;

FIG. 5 illustrates a method of maintaining a fleet of pressurized fluid tanks in accordance with one embodiment described herein; and

FIG. 6 illustrates a flowchart of a series of acts in a method of maintaining a pressurized fluid tank in accordance with one embodiment described herein.

### DETAILED DESCRIPTION

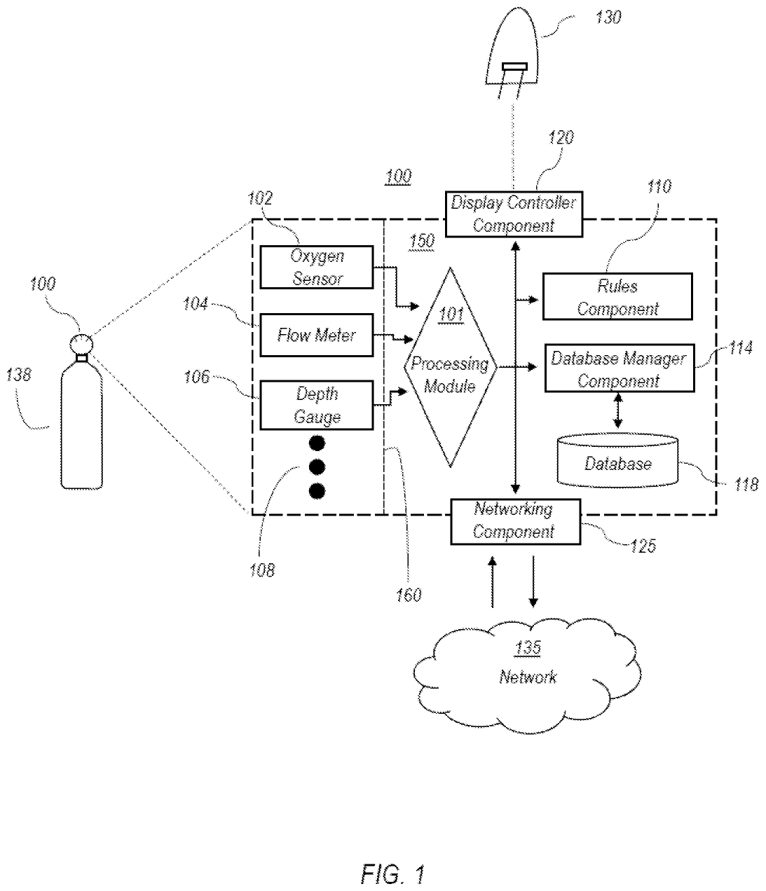

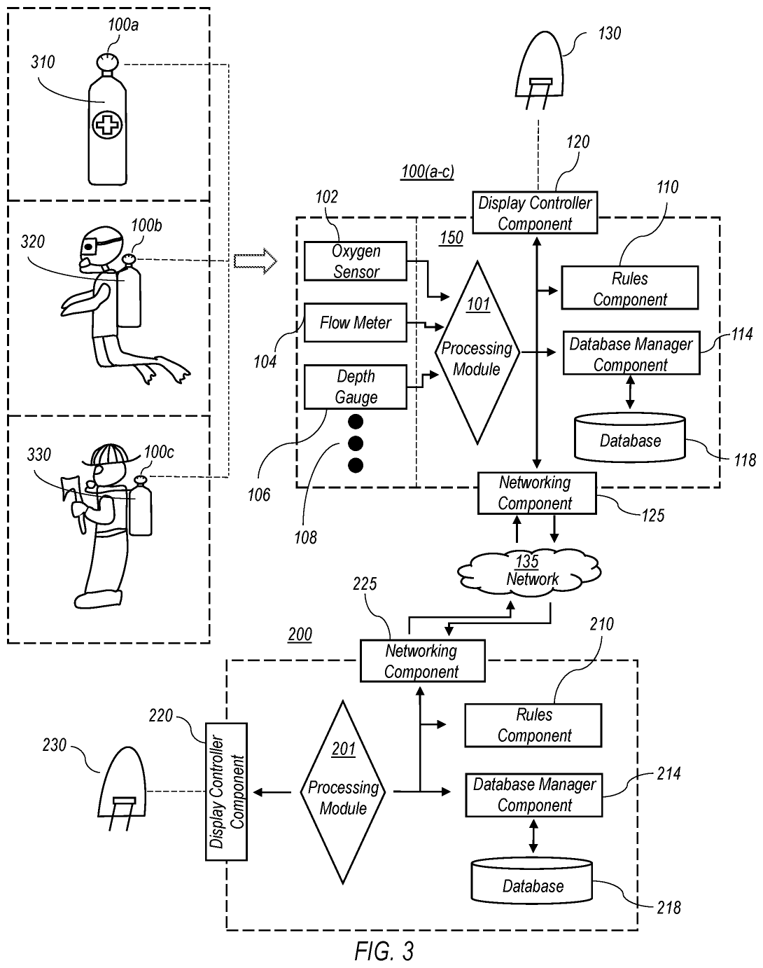

Embodiments described herein provide systems, methods, and computer program products related to monitoring one or more pressurized fluid tanks, and providing clear, real-time, immediately understandably notifications of status, such as oxygen capacity. In at least one implementation, a pressurized fluid tank monitoring device or system provides accurate, real-time, and visual notice regarding pressurized fluid data of a pressurized fluid in a pressurized fluid tank, such as through one or more visible indicators, such as one or more light sources. The disclosed visual indicators provide significant advantages to efficiency, and predictability of pressurized fluid tanks, as they can allow for a much simpler and faster way to ascertain the status of a pressurized fluid in a pressurized fluid tank. As used herein, the term “fleet” refers to one or more pressurized fluid tanks in a group. Additionally, while a particular shape is used to illustrate embodiments described herein throughout the Figures (e.g., 100 in FIG. 1, 100a, 100b, 100c in FIG. 3), embodiments described herein are not limited to any single shape, color, size, or any other physical appearance.

FIG. 1 illustrates a schematic of a pressurized fluid tank monitoring device 100 configured to provide notice regarding pressurized fluid data of a pressurized fluid inside a pressurized fluid tank in accordance with one embodiment described herein. For example, FIG. 1 shows that the pressurized fluid tank monitoring device 100 may contain a computer system 150 comprising a processing module 101, one or more digital sensors 102, 104, 106, a rules component 110, a database manager component 114, a database 118, a display controller component 120, and a networking component 125. As used herein, the term ‘managing components’ refers to any combination of the rules component 110, the database manager component 114, the display controller component 120, the networking component 125, and any other component that may be used to allow for functionality of the pressurized fluid tank monitoring device 100.

By way of explanation, terms such as “module” 101 and “component” (110, 114, 120, 125) will be understood as abstractions of generalized processing components that can be used in at least one implementation of embodiments described herein, and there may be more or fewer than those illustrated and described, and as may be suited for a particular server and cloud operating environment. As used herein, a “module” means computer executable code that, when executed by one or more processing modules at a given computer system (e.g., computer system 105, or server 120), causes the given computer system to perform a particular function. By contrast, a “component” means a passive set of instructions or data structures or records that store, manage, and/or otherwise provide information handled through a given module. One of skill in the art, however, will appreciate that the distinction between different modules or components is at least in part arbitrary, and that modules or components may be otherwise combined and divided in different ways and still remain within the scope of the present disclosure. As such, the description of a component as being a “module” or a “component” is provided only for the sake of clarity and explanation and should not be interpreted to indicate that any particular structure of computer executable code and/or computer hardware is required, unless expressly stated otherwise. In this description, the terms “component,” “manager,” “service,” or the like may also similarly be used.

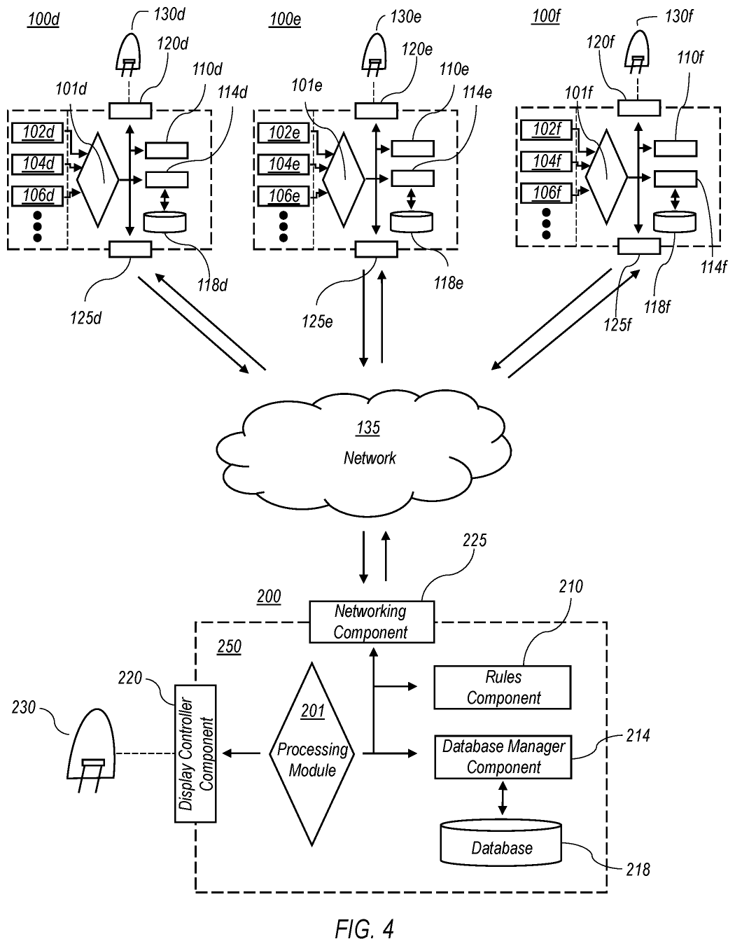

Returning now to the Figures, FIG. 1 shows that the pressurized fluid tank monitoring device 100 may be attached to a pressurized fluid tank 138. One of ordinary skill will appreciate from the present specification and claims that the pressurized fluid tank 138 may be a medical oxygen tank, a scuba tank, a firefighter's oxygen tank, or any other tank that holds a pressurized fluid. As discussed more fully herein, one will appreciate that the pressurized fluid tank monitoring device 100 can also be assigned a unique identifier (see also FIG. 4, 100d-f) that distinguishes it from other pressurized fluid tank monitoring devices, such as in a fleet of tanks.

FIG. 1 also shows that monitoring device 100 can comprise a computing system 150, which in turn is operably connected with one or more digital sensors 102, 104, 106. One will appreciate that, while only three sensors are shown in FIG. 1, any number of sensors may be used with the pressurized fluid tank monitoring device 100. In one implementation, the sensors 102, 104, 106 can comprise a sensor that measures total level of oxygen, a pressure sensor, an atmospheric barometer, a thermometer, a depth gauge, a flow meter, and/or any other number or type of sensor for a particular use environment. For example, temperature and barometer may be more relevant to emergency personnel (e.g., firefighting personnel) while a depth gauge or altimeter may be more relevant for underwater use. The one or more digital sensors 102, 104, 106 can be configured to sense a variety of types of pressurized fluid data within tank 138, including pressure, volume, temperature, rate of fluid flow, and depth.

In any event, FIG. 1 shows that the one or more digital sensors 102, 104, 106 of the device can be connected to the illustrated tank 138, which, as described, may include a scuba tank, a medical oxygen tank, a firefighter's oxygen tank (see also FIG. 3, 310, 320, 330) or the like. Other implementations may include oxygen tanks for use in aerospace applications. In general, the sensors 102, 104, 106, identify metrics about the pressurized fluid within tank 138, as well as environmental data outside of the tank 138. In one or more additional implementations, the monitoring device 100 could include one or more biometric sensors, which may a given individual's record heart rate or other biophysical indicators that may be relevant to oxygen/fluid intake. Data recorded by the one or more digital sensors 102, 104, 106 can be sent to the computer system 150 and can be sent to the processing module 101 of the computer system 150.

FIG. 1 also shows that the rules component 110 of the pressurized fluid tank monitoring device 100 can include rules that govern the functionality of the pressurized fluid tank monitoring device 100, including but not limited to the illumination of one or more light sources 130, the transmission and retrieval of data over a network 135, the determination of one or more colors based off of data received from the one or more digital sensors 102, 104, 106, and the storage and retrieval of data in a database 118.

Additionally, FIG. 1 shows that the database manager component 114 can have the ability to store data to—and retrieve data from—the database 118. The database manager component 114 can have the ability to send data to and receive data from the processing module 101. The database 118 can be configured to store unprocessed or processed data. The database 118 also can be configured to store a variety of types of data, including pressure, volume, temperature, rate of fluid flow, estimated time remaining in the tank, depth, other pressurized fluid data, and system configuration information.

FIG. 1 also shows that the networking component 125 can transmit and receive data over a network 135. The network 135 can operably connect one or more other pressurized fluid tank monitoring devices to each other. The network 135 also can operably connect one or more pressurized fluid tank monitoring devices to a central server.

In addition, FIG. 1 shows that the display controller component 120 can operably connect the computer system 150 to one or more lighting sources 130. For example, the display controller component 120 can be connected to a single LED light or a plurality of LED lights and can provide rendering instructions to the one or more lighting sources 130. For example, the light source 130 may represent a collection of light sources as part of an LCD display screen with a user interface, and the display controller component 120 can be connected to an LCD screen. The one or more lighting sources 130, in turn, can be configured to display colors based on a status of the pressurized fluid. As used herein, the terms “warning level” and “status” are synonymous in function, and both reflect that there is information being communicated to the user about the pressurized fluid data that the processing module 101. In such a way, the processing module 101 can determine one or more colors to illuminate according to the pressurized fluid data that the procession module 101 receives.

For example, a first color such as green can indicate that there is a good or positive status. A second color such as red can indicate a bad or warning status and can further indicate a change in the pressurized fluid data received by the processing module 101 that may indicate that maintenance is necessary. Various other colors (and other indicium outlined herein) can be included to provide indications of rate of change, or even compositional issues, such as fluid composition (e.g., relative percent of nitrogen or carbon dioxide detected) within the oxygen tank. The different statuses can be used to indicate that maintenance is necessary on the pressurized fluid tank 138 to which the pressurized fluid tank monitoring device 100 is attached. The one or more lighting sources 130 can also be a display configured to display the pressurized fluid data captured by the one or more sensors 102, 104, 106, which can indicate various rates of change in pressure or composition within the tank, which can be used to provide more accurate, real-time, at-a-glance information regarding how soon the pressurized tank may be approaching more critical levels requiring a red warning. For example, the monitoring device 100 may display a transition from green, to blue, to orange, to red, or some other combination of sequence of colors or other relevant data as the oxygen depletes. Moreover, the monitoring device 100 may render the one or more light sources 130 to display additional colors that indicate a rate of depletion, or other relevant tank 138 or outside environmental data that can affect the same.

In still further cases, the monitoring device 100 can also display various numerical data. In particular, the computing system 150 can calculate a numerical value related to flow rate, and time remaining at the given flow rate until reaching various threshold values. For example, the computing system 150 may determine via the flow meter 104 and/or oxygen sensor 102 that there are approximately 10 minutes remaining in the tank 138. The computing system 150 may then send one or more signals from the display controller component 120 to the monitoring device 100 to update the display to indicate 10 minutes remain of pressurized fluid. In additional examples, the computing system 150 can instruct the monitoring device 100 to display a countdown timer, that updates ever several seconds, or minutes, as applicable. The change in color from the LEDs 130 can also be correlated to the given timing level. For example, the computing system 150 may instruct the lighting sources/LEDs 130 to change to one color with 20 minutes left, another color with 15 minutes left, still another color or intensity with 10 minutes left, and so on.

In still further examples, the computing system 150 may correlate the displayed time, color, color intensity, etc. in relation to the type of use environment. For example, in a hospital setting, the pressurized fluid flowrate may tend to be constant, such that the computing system 150 may instruct the monitoring device 100 to provide a display update only every 5 or 10 minutes. With a larger supply of replacement tanks and readily available atmospheric air, the urgency in the numerical display may be lower in a hospital setting. In more variable use/oxygen scarcity cases (low levels of replacement), such as with firefighters, or underwater usage, the computing system 150 may update the monitoring device to show the remaining oxygen (or other pressurized fluid) at a few minutes at a time, or even a few seconds, or even a second-by-second countdown timer.

In still further cases, the computing system 150 may comprise one or more sensors for outside conditions, which in turn cause a change in frequency by which the remaining availability is presented on the monitor 100, such as based on a sensor level of oxygen outside of the tank. For example, in a fire or underwater situation, the computing system 150 may identify that oxygen outside of the tank is low (in firefighting), or essentially non-existent (e.g., underwater), and may switch the monitor 100 from a less frequent report to a more frequent report of remaining oxygen. This could result in the computing system 150 changing the display both numerically and from a color/color intensity or brightness from an interval of a few minutes per update to a continuous update every minute or second.

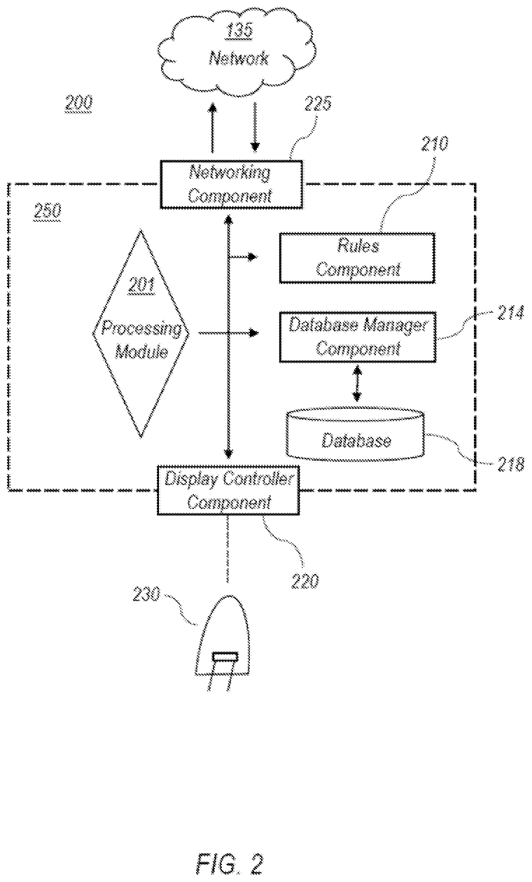

FIG. 2 shows a schematic of a central server 200 that can be used in connection with monitoring device 100 and one or more other monitoring devices with one or more other tanks (see also FIG. 4), in accordance with one embodiment described herein. As shown in FIG. 2, for example, the central server 200 can contain a processing module 201, a rules component 210, a database manager component 214, a database 218, a display controller component 220, and a networking component 225. Each individual component may be configured in a similar manner to the corresponding components (110, 114, etc.) of the pressurized fluid tank monitoring device 100 of FIG. 1. In order to herein distinguish the central server components from the pressurized fluid tank monitoring device components, the phrase ‘central server’ may be added before the listed component, or special attention may be paid to the reference number listed after the component with reference to the appropriate Figures.

Returning to the figures, FIG. 2 shows that the central server 200 can communicate over a network 135 with one or more pressurized fluid tank monitoring devices to receive pressurized fluid data from the one or more pressurized fluid tank monitoring devices (see also FIG. 4, 225).

In addition, FIG. 2 shows that the central server 200 can also control one or more light sources 230 (much as monitoring device 100 operates light source 130) through its display component 220, allowing a user to monitor the one or more pressurized fluid tank monitoring device on the network simultaneously. For example, the one or more light sources 230 can be a plurality of LEDs such that each LED in the plurality of LEDs is assigned to a different pressurized fluid tank monitoring device that is connected to the network. In such a configuration, each individual LED can display a warning level associated with the pressurized fluid data that comes from the pressurized fluid tank monitoring device assigned to that LED. In another implementation, the one or more light sources 230 can comprise a display that is configured to display the pressurized fluid data (and associated color and/or numerical or other indicium) associated with each pressurized fluid tank monitoring device that is connected to the central server 200.

The database manager component 214 can store data to and retrieve data from the database 218. The database manager component 214 can send data to and receive data from the processing module 201. The database 218 can be configured to store unprocessed or processed data from one or more pressurized fluid tank monitoring devices. The database 218 can also be configured to store configuration information regarding one or more pressurized fluid tank monitoring devices. The central server 200 thus can have persistent memory of devices previously connected with the central server 200 over the network 135. The central server 200 can thus be configured to maintain fleets of pressurized fluid tanks, each tank having its own pressurized fluid tank monitoring device (e.g., the pressurized fluid tank monitoring device 100 of FIG. 1).

Turning now to the rules component 210, the rules component 210 may contain rules that govern the functionality of the central server 200 in a similar manner to the rules component 110 of the pressurized fluid tank monitoring device 100 of FIG. 1. For example, the central server rules component 210 can contain rules governing the illuminating of one or more light sources 220 and the storage and retrieval of data from a database 218.

Additionally, the central server 200 can contain rules that govern the administration of the client-server interactions between the central server 200 and one or more pressurized fluid tank monitoring devices. For example, one rule can govern the ability to add or remove client pressurized fluid tank monitoring devices to or from the central server 210. As another example, one rule can govern the maintenance, processing, and analysis of pressurized fluid data from one or more pressurized fluid tank monitoring device clients. The central server 200 may thus assume some of the computational load from the one or more pressurized fluid tank monitoring device clients. Thus, the central server 200 can facilitate the maintenance of a fleet of pressurized fluid tanks, each tank having its own pressurized fluid tank monitoring device.

FIG. 3 illustrates a system that includes a pressurized fluid tank monitoring device 100(a-c) and a central server 200 in accordance with one embodiment described herein. According to FIG. 3, the pressurized fluid tank monitoring device 100(a-c) can be attached to a pressurized fluid tank in any number of different environments. As examples, the pressurized fluid tank can be used in a hospital to provide patient care and support as a medical oxygen tank 310 with pressurized fluid tank monitoring device 100a, with scuba gear as a scuba tank 320 with pressurized fluid tank monitoring device 100b, with firefighters as a firefighter's oxygen tank 330 with pressurized fluid tank monitoring device 100c, and/or in an unlimited number of other environments and configurations. Regardless of the environment in which it is used, the pressurized fluid tank monitoring device 100(a-c) can be attached to a pressurized fluid tank in order to ascertain pressurized fluid data regarding a pressurized fluid inside the pressurized fluid tank 310, 320, 330 to which the pressurized fluid tank monitoring device 100(a-c) is attached.

In each environment, pressurized fluid data is captured by the one or more digital sensors 102, 104, 106. For example, if a pressurized fluid tank is used in a hospital as a medical oxygen tank 310, then the pressurized fluid data can include information about the pressure in the tank 310, the volume of the tank 310, and the maximum flow rate possible of the fluid through the oxygen tank monitoring device 100(a-c). As another example, if a pressurized fluid tank is used as a scuba tank 320, then the pressurized fluid data can include information about the pressure in the scuba tank 320, the volume of the scuba tank 320, the depth of the scuba tank 320, and the rate at which fluid is escaping the scuba tank 320 through the pressurized fluid tank monitoring device 100(a-c). As another example shown in FIG. 3, if the pressurized fluid tank is used as a firefighter's oxygen tank 330, then the pressurized fluid data can additionally include information relating to the temperature of the firefighter's oxygen tank 330 as well as the temperature of the surrounding environment.

The current pressurized fluid data can be captured in real-time by one or more digital sensors 102, 104, 106 operably connected to the pressurized fluid tank monitoring device 100(a-c), or by one or more digital sensors 102, 104, 106 in the pressurized fluid tank monitoring device 100(a-c). The captured data can be sent by any medium capable of transferring data to the processing module 101 of the pressurized fluid tank monitoring device 100(a-c). For example, a data line could be used to connect the one or more sensors 102, 104, 106 to the processing module 101.

As shown in FIG. 3, The processing module 101 of the pressurized fluid tank monitoring device 300 can process and analyze received data from the one or more sensors 102, 104, 106. The processing module 101 can do so using a rules component 110. For example, the processing module 101 can use a rule from the rules component 110 that determines what color and which lighting source to illuminate based on the data being processed. As another example, the processing module 101 can use a rule from the rules component 110 to determine whether to store the data into the database 118 using the database manager 114. As an additional example, the processing module 101 can use a rule from the rules component 110 to determine whether to send data to the networking component 125 for delivery over a network 135.

As yet another example, the processing module 101 can use a rule from the rules component 110 to determine how to process the received data from the one or more digital sensors 102, the rule governing the processing of data containing information regarding pressurized fluid data. Such a rule can, for example, govern the conversion of raw data into a human-readable format. In one implementation, the processing module 101 can use rules from the rules component 110 to determine a status of the pressurized fluid tank from the data received. The determined status can be good, neutral, or bad depending on thresholds established by the rules in the rules component 110. The determined status can also be variable warning levels, from none to extreme.

In one embodiment, a rule can be used to analyze the received data with information relating to various human metrics. For example, human metrics can include weight, exertion level, and breathing rate. As an illustrative principle, individuals with a higher weight tend to consume pressurized fluid at a faster rate than those individuals with a lower weight. Therefore, different individuals can exhaust a supply of pressurized fluid at unique rates. Thus, a rule can use information regarding the weight of an individual in relation to pressurized fluid data of a pressurized fluid in order to determine how much longer that individual can continue consuming the pressurized fluid before a supply of the pressurized fluid in a pressurized fluid tank is exhausted. Similar principles apply to an individual's exertion level and breathing rate.

Additionally, in the case of a scuba diver, information regarding the depth of the tank can be used to determine the amount of time remaining before the diver needs to return to the surface. The depth at which a diver is diving directly affects the rate of pressurized fluid consumption. As depth increases, the ambient pressure also increases, causing the diver to breathe in a higher concentration of pressurized fluid. This results in a faster consumption of pressurized fluid. Thus, in one embodiment, a rule can analyze the received data in view of the depth of the pressurized fluid tank monitoring device 100(a-c) to determine how long a diver has before they must return to the surface. The pressurized fluid tank monitoring device 100(a-c) can then alert the diver of the time remaining using its one or more light sources 130.

For example, a single yellow LED can indicate a small amount of time remaining at a given consumption rate of a supply of pressurized fluid in a pressurized fluid tank (e.g., 5 minutes remaining in a scuba dive, 3 minutes remaining of patient care in a hospital). As another example, the one or more light sources 130 can be configured to display a real-time calculated amount of time remaining based on pressurized fluid data received by the pressurized fluid tank monitoring device 100(a-c). According to some embodiments described herein, one or more rules can thus be used to make the real-time calculation of the amount of time remaining and to display the calculated amount.

According to FIG. 3, the processing module 101 can send and receive data to and from the database manager component 114 of the pressurized fluid tank monitoring device 100(a-c). These data can be processed or unprocessed and can come from one or more digital sensors 102, 104, 106 operably connected to or part of the pressurized fluid tank monitoring device 100(a-c). For example, the processing module 101 can send processed data to the database manager component 114. The database manager component 114 can then store the received data into a database 118. As another example, the processing module 101 can request data from the database manager component 114, and the database manager component 114 can retrieve the requested data from the database 118.

As shown in FIG. 3, the processing module 101 can send data to a display controller component 120. The display controller component 120 can send the received data to one or more lighting sources. Possible lighting sources include a single LED light, multiple LED lights, a liquid crystal display, or any other medium capable of producing light. For example, the processing module 101 can use a rule from the rules component to determine what color or colors to illuminate on one or more lighting sources 130 and then send that color or those colors to the display controller component 120. The display controller component 120 can then cause the received color or colors to be illuminated on one or more lighting sources. In one implementation, the processing module 101 can use rules from the rules component 110 to determine a warning level of the pressurized fluid tank from the data received from the one or more digital sensors 102 and what color or colors to illuminate based on that warning level. For example, there can be various possible warning levels that range from low to high, with colors ranging from green to red, respectively, for each level of warning. There can also be different statuses, ranging from good to bad, with colors ranging from green to red, respectively, for each status.

FIG. 3 also shows that the processing module 101 can send the determined color or colors to the display controller component 120. The display controller component 120 can send rendering instructions for the determined color or colors to one or more lighting sources 130 in real-time. For example, if the determined warning level was high, then the display controller component can send data from the processing module 101 to illuminate a single red LED, or other relevant shade or brightness thereof depending on the severity. As another example, if the determined warning level was moderate, then the display controller component 120 can send data from the processing module 101 to display a warning sign on an LCD screen. If the oxygen is in a flowrate that will deplete more quickly, the processing module 101 can send out instructions for perhaps a different shade or brightness that reflects the moderate-but-encroaching-on-warning status. As yet another example, if the determined warning level was low, then the display controller component 120 can send data from the processing module 101 to illuminate a single green LED. The display controller component 120 can also be configured to illuminate a display with the received pressurized fluid data, thus rendering the pressurized fluid data in a human-readable form.

According to FIG. 3, the processing module 101 can send data to a networking component 125. The networking component 125 can send the received data over a network 135 to one or more pressurized fluid tank monitoring devices or to the networking component 225 of a central server 200. FIG. 3 also shows that the networking component 175 of the central server 200 can send the received data to a central server processing module 201. For example, the central server 200 can receive pressurized fluid data from one or more pressurized fluid tank monitoring units from the network 135. The central server 200 can send all of these data to the central server processing module 201. The central server 200 can also be configured to retrieve these data at a fixed interval of time, for example every half a second or other relevant interval, such as dependent on available power or battery levels. Retrieving pressurized fluid data can comprise using the networking component 225 of the central server 200 to communicate with the networking component 125 of the pressurized fluid tank monitoring device 100 in such a way that the pressurized fluid monitoring device 100 sends pressurized fluid data to the central server 200 whenever the central server 200 instructs the pressurized fluid tank monitoring device 100 to do so. In such a configuration, the central server 200 can be used to monitor multiple pressurized fluid tank monitoring devices regularly or at regular intervals.

As shown in FIG. 3, the central server processing module 201 can process the received data. The central server processing module 201 can do so using a central server rules component 210. The central server rules component 210 can have similar rules found in the rules component 110 of the pressurized fluid tank monitoring system 100, or the central server rules component 210 can have different rules from the rules component 110. For example, the central server rules component 210 can contain a rule to separate incoming data and group them according to the pressurized fluid tank monitoring device from which the data came, and thus sort them by a combination of tank identity, oxygen levels, available flowrates, and the like

As another example, the central server rules component 210 can contain a rule to perform advanced processing, such as when the received data arrive unprocessed. Doing so can reduce some of the computational load on each individual pressurized fluid tank monitoring device connected through the network 135 to the central server 200. As an example, the central server processing module 201 can use a rule from the central server rules component 210 to determine how to process the received data, such as processing raw data into a human-readable format, or to process other raw data to produce various flow rate, composition, or completion metrics. As another example, the central server processing module 201 can use a rule from the central server rules component 210 to determine whether any of the data indicate a bad status for a corresponding pressurized fluid tank (e.g., 310, 320, or 330). Such a rule can also allow the central server processing module 201 to determine a color to illuminate.

FIG. 3 additionally shows that the central server processing module 201 can send data to and receive data from a central server database 218 through a central server database manager component 214. In one implementation, the central server database manager 214 can manage data for one or more pressurized fluid tank monitoring devices attached to the network 135 by storing the data in the database 218. For example, the central server processing module 201 may determine one or more colors to illuminate based on data received from one or more pressurized fluid tank monitoring devices. The central server processing module 201 may then store the determined color or colors to and/or retrieve the determined color or colors from the database 218.

The central server processing module 201 can send data to a central server display controller component 220. The central server display controller component 220 can send the received data to one or more lighting sources operably connected to the central server 201. These one or more light sources can comprise a central server display 230, such as may be used and operated by a manager at a remote location (even if in close proximity). The central server display controller component 220 can be configured in a similar manner to the display controller component 120 of the pressurized fluid tank monitoring device 100. For example, the remote user could be another diver, such as a supervising diver that is diving with one or more other divers at the same time. The remote user could be a centralized firehouse operator while various other users are using different monitoring devices on site in an emergency situation. In other cases, the remote user may be a companion user that is using another pressurized fluid tank in close proximity to another user using yet another pressurized fluid tank.

The central server processing module 201 can send data back to the central server networking component 225. The central server networking component 225 can send data back to one or more pressurized fluid tank monitoring devices connected to the network 135. For example, the central server processing module 201 may determine a color to illuminate based on data received from a pressurized fluid tank monitoring device. The central server processing module 201 may then send the determined color to the pressurized fluid tank monitoring device so that the pressurized fluid tank monitoring device may illuminate the determined color.

FIG. 4 illustrates a schematic of an interaction between a central server 200 and one or more pressurized fluid tank monitoring device 100d, 100e, 100f clients in accordance with one embodiment described herein. While three pressurized fluid tank monitoring devices 100d, 100e, 100f are shown, the interaction between the pressurized fluid tank monitoring devices 100d, 100e, 100f and the central server 200 can include any number of pressurized fluid tank monitoring devices; the three pressurized fluid tank monitoring devices 100d, 100e, 100f shown are merely symbolic of the any number of such devices that may be included in an embodiment described herein.

FIG. 4 shows that each pressurized fluid tank monitoring device 100d, 100e, 100f can be connected to any combination of other pressurized fluid tank monitoring devices 100d, 100e, 100f through the network 135. For example, each pressurized fluid tank monitoring device 100d, 100e, 100f can be distinct one from another with, for example, distinct processers 101d, 101e, 101f, distinct sensors 102d, 102e, 102f, distinct rules components 110d, 110e, 110f, distinct networking components 125d, 125e, 125f, and distinct display controller components 120d, 120e, 120f. In such a configuration, the central server 200 may monitor the pressurized fluid data of one or more distinct pressurized fluid tanks. This may enable rapid data acquisition and analysis for a fleet of such tanks.

As shown in FIG. 4, each pressurized tank monitoring device 100d, 100e, 100f can be connected to a central server 200 through the network. in this way, each individual pressurized fluid tank monitoring device 100d, 100e, 100f can act as a client to the central server 200. Data can be sent from each device 100d, 100e, 100f to the central server 200, and data can be sent from the central server 200 to each device 100d, 100e, 100f. One possible benefit of such a system can be the division of computational labor across the pressurized fluid tank monitoring device 100d, 100e, 100f clients and the central server 200. Data can also be sent between pressurized fluid tank monitoring devices 100d, 100e, 100f over the network 135.

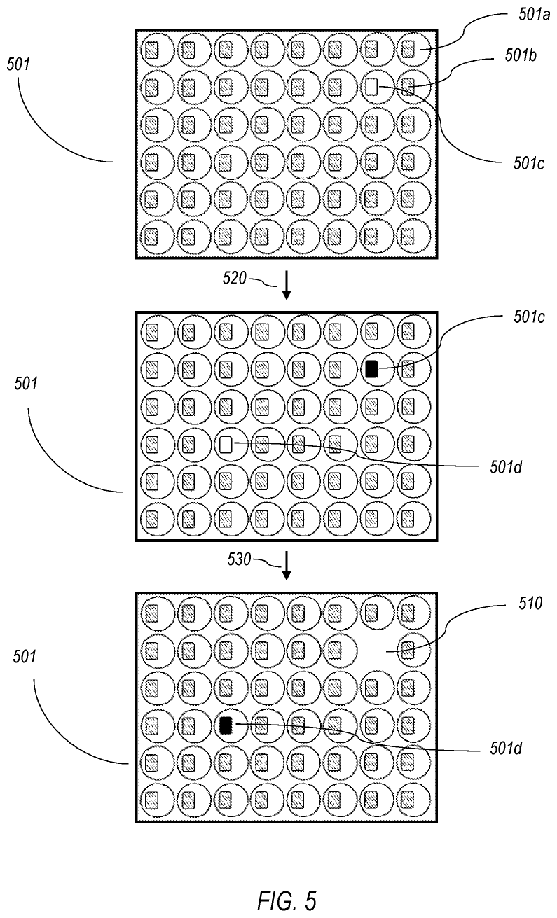

FIG. 5 illustrates a broad view of a system of maintaining a fleet of pressurized fluid tanks in accordance with an embodiment herein described. For example, FIG. 5 shows that each pressurized fluid tank (e.g., 501a, 501b) can be equipped with respective monitoring device (e.g., 100, FIG. 1), which in turn provides data viewable with other tanks to a remote user. That is, a fleet of pressurized fluid tanks 501 can comprise individual pressurized fluid tanks 501a grouped together into the fleet 501. In the system, each pressurized fluid tank 501a can include an embodiment described herein 501b to illuminate a same color except for at least one embodiment described herein 501c, which can indicate that the pressurized fluid data of the pressurized fluid tank attached to the embodiment described herein 501c is different than the other tanks. In one embodiment, the difference can signify a warning level of pressurized fluid in that tank and can also be used to identify the tank to which the embodiment 501b is attached.

FIG. 5 also shows the fleet of pressurized fluid tanks 501, such as at some arbitrary amount of time later (shown by arrow 520). The embodiment 501c illuminates yet another different color (or shade, brightness, hue, etc.), which can indicate a change in pressurized fluid data that may indicate how soon a given tank may be depleted based on various operating conditions, user conditions, or that maintenance is necessary on the pressurized fluid tank to which the embodiment 501c is attached. A different embodiment described herein 501d also illuminates a different color/shape/brightness/hue, which can indicate a change in pressurized fluid data of the pressurized fluid tank to which it is attached.

Additionally, FIG. 5 also shows the fleet of pressurized fluid tanks 501, perhaps some arbitrary amount of time even later (shown by arrow 530). The pressurized fluid tank to which embodiment 501c is attached can be removed for maintenance leaving space 510. The different embodiment described herein 501d changes its illuminated color, which can indicate a change in its pressurized fluid data that may indicate that maintenance is necessary on the tank to which it is attached.

In one embodiment, the fleet of pressurized fluid tanks 501 may be shown on a digital display. Pressurized fluid data can be received for each of a plurality of pressurized fluid tanks in the fleet of pressurized fluid tanks 501, the pressurized fluid data corresponding to each of one or more pressurized fluid tank monitoring devices. The received pressurized fluid data can be processed for each pressurized fluid tank to determine a warning level for each pressurized fluid tank. One or more pressurized fluid tanks can be identified from the plurality of pressurized fluid tanks based on the determination of warning level. Rendering instructions for an alert to be displayed on a digital display can be provided, and the alert can indicate a need for maintenance on the identified one or more pressurized fluid tanks.

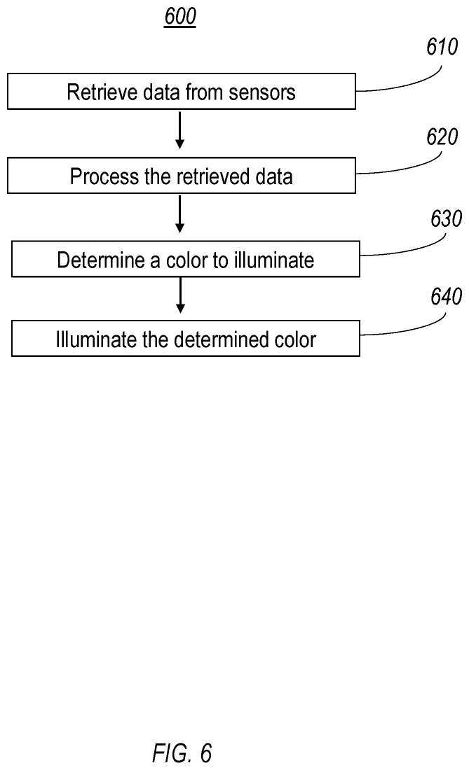

In addition to the foregoing, the present invention can also be described in terms of one or more acts in a method for accomplishing a particular result. For example, FIG. 6 illustrates a flowchart of a sequence of acts in a method providing notice regarding pressurized fluid data of a pressurized fluid inside a pressurized fluid tank. The acts and steps of FIG. 6 are described below with reference to the components and modules in FIGS. 1 through 5.

For example, FIG. 6 shows that method 600 can comprise an act 610 of retrieving data from one or more sensors. Act 610 includes retrieving pressurized fluid data of the pressurized fluid from one or more digital sensors communicably coupled with a pressured fluid tank. For example, FIG. 3 shows that monitoring device 100 is in communication with and receives pressurized fluid data from tank 310 via one or more sensors 102, 104, 106. The monitoring device may be attached or otherwise embedded within the given tanks (310, 320, 330), or, as shown in FIG. 5, to each pressurized fluid tank in a given fleet of tanks 502 (e.g., a fleet of medical, scuba, firefighters, emergency, etc.).

FIG. 6 also shows that method 600 can comprise an act 620 of processing the retrieved data. Act 620 includes processing the retrieved pressurized fluid data. For example, FIG. 3 shows that the processing module 101 can process the retrieved pressurized fluid data using one or more rules from the rules component 110. FIG. 3 also shows that part of the processing can include the processing module 101 sending either processed or unprocessed data through the database manager component 114 to the database 118.

In addition, FIG. 6 shows that method 600 can comprise an act 630 of determining a color to illuminate. Act 630 includes determining a first color that is associated with the retrieved pressurized fluid data. For example, FIG. 3 shows that the processing module 101 determines a color using data from the one or more digital sensors 102, 104, 106 and illuminates the determined color on the one or more lighting sources 130 through the display controller component 120. The determined color/shade/hue/brightness can indicate a status of a pressurized fluid inside a pressurized fluid tank to which a pressurized fluid tank monitoring device 100 is attached. For example, the determined color can be red for a bad status, green for a good status, and yellow for a warning status. The colors can also be adjusted by brightness, tone, or other visible metric to show rates of change, relative closeness to a warning indicator, or other relevant data that reflects both real-time, just-in-time information, as well as impending status data.

Furthermore, FIG. 6 also shows that method 600 can comprise an act 640 of illuminating the determined color. Act 640 includes displaying on a digital display the determined first color. For example, FIG. 3 shows a digital display in the form of one or more light sources 130. The digital display can comprise a formal digital user interface such as a television or a computer screen, or something simpler such as one or more individual LEDs. Regardless of what the digital display comprises, the determined color is illuminated, which conveys to the viewer information about a status of a pressurized fluid inside a pressurized fluid tank. As an example, the illuminated color can be red for a bad status, green for a good status, and yellow for a warning status. In still further embodiments, the display can show a time value that is correlated with the color, and represents an amount of time remaining before the fluid is depleted. This time value can be updated at the same frequency as the displayed color, or at more frequent intervals depending on the usage case (e.g., standard flowrate, or variable/emergent flowrate).

Additionally, one will appreciate the system may iteratively perform these steps several times, and several sets of times and continually update one or more light sources in real-time with changes in status of a pressurized fluid. Performed multiple times, the method 600 can determine a color in Act 640 that can be different than the last time the method 600 was performed if there is a change in pressurized fluid data. For example, upon receipt of a change in pressurized fluid data, Act 640 may display on the digital display a second color that is different from a first determined color, the first determined color being from an earlier performance of Act 640 of method 600. The system may also update a time displayed on the monitor 100, which can show an updated time before the fluid is depleted. The time value, again, may be updated continuously, or every few seconds, or minutes, depending on the usage case.

One will appreciate, therefore, in view of the present specification and claims that embodiments of the present invention can be practiced in a wide range of settings contributing to safety, efficiency, and predictability. In hospitals, where oxygen tanks are used during surgeries, patient transportation, and critical care, embodiments of the present invention can ensure medical personnel are aware of the remaining oxygen supply. This prevents unexpected depletion of oxygen during crucial procedures or transport, which could jeopardize patient lives. Similarly, scuba divers could rely on embodiments of the present invention to monitor their air supply underwater, where timely access to the surface is limited. A sudden loss of oxygen underwater could lead to serious, even fatal, accidents. Embodiments of the present invention can address at least these circumstances by providing an illuminated color that shows the status of a pressurized fluid in a pressurized fluid tank, drastically improving the ease of use of pressurized fluid tanks because the user can quickly ascertain the status of the pressurized fluid in the tank. In this way, embodiments of the present invention greatly improve the safety, efficiency, and predictability of pressurized fluid tanks, as they allow for a much simpler and faster way to ascertain the status of a pressurized fluid in a pressurized fluid tank.

For example, embodiments of the present invention can provide operational efficiency, allowing staff to schedule replenishments and maintenance appropriately. In environments such as space stations or submarines, where the outside environment is inhospitable, embodiments described herein can allow precise management of resources, which is critical to maintaining habitability and performing tasks. Furthermore, embodiments can also serve as a safety feature against overfilling a pressurized fluid tank, which could result in dangerous over pressurization. Embodiments of the present invention can also provide information custom tailored to the human metrics of a user of a pressurized fluid tank to which the embodiment is attached. For example, different users of scuba tanks may have different consumption rates of the fluid therein, and, as such, the pressurized fluid data that may indicate a warning level for one person may not for another. The embodiments may account for these differences to provide warnings custom tailored to the user of the embodiments, improving safety for all users. Hence, embodiments of the present invention, with their ability to provide real-time, accurate data on pressurized fluid status, offer an invaluable combination of safety, efficiency, and peace of mind in diverse and demanding environments.

The present invention may comprise or utilize a special-purpose or general-purpose computer system that includes computer hardware, such as, for example, one or more processing modules and system memory, as discussed in greater detail below. The scope of the present invention also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processing modules, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processing modules, hand-held devices, multi-processing module systems, microprocessing module-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention can also be described in terms of various configurations, including various alternative configurations. For example, at least one configuration includes a pressurized fluid tank monitoring device configured to provide notice regarding pressurized fluid data of a pressurized fluid inside a pressurized fluid tank, comprising: a pressurized fluid tank; a computer system communicably attached to the pressurized fluid tank, having (i) a processing module; (ii) one or more digital sensors; and (iii) one or more managing components; and a display communicably connected to the computer system, the display having one or more LED light sources; wherein the computer system is configured to: retrieve and process pressurize fluid data from one or more digital sensors to determine current pressurized fluid data of the pressurize fluid inside the pressurized fluid tank; and illuminate the display according to the determined pressurized fluid data.

In an additional or alternative configuration, the display comprises a plurality of LEDs. In an additional or alternative configuration, the display can be configured such that: when the pressurized fluid data indicates a first warning level, the display is illuminated a first color, and when the pressurized fluid data indicates a different warning level, the display is illuminated a color that is different than the first color. In an additional or alternative configuration, the display can be configured to show the pressurized fluid data, and a numerical value representing an amount of time left before depletion. In an additional or alternative configuration, the pressurized fluid tank is a scuba tank. In an additional or alternative configuration, the pressurized fluid tank is a medical oxygen tank.

In an additional or alternative configuration, the pressurized fluid tank is a firefighter's oxygen tank. In an additional or alternative configuration, the computer system is further configured to: before processing the retrieved pressurized fluid data, store the unprocessed pressurized fluid data in a database; and after processing the retrieved pressurized fluid data, store the processed pressurized fluid data in a database. In an additional or alternative configuration, the computer system is further configured to: before processing the retrieved data, send the unprocessed pressurized fluid data over a network to a central server; and after processing the retrieved data, send the processed pressurized fluid data over a network to a central server.

Further configurations can comprise a system for monitoring a plurality of pressurized fluid tanks through a network, including: a central server communicably connected over a network to one or more pressurized fluid tanks, wherein each pressurized fluid tank comprises: a computer system communicably attached to its corresponding pressurized fluid tank, the computer system having (i) a processing module; (ii) one or more digital sensors; and (iii) and a managing component; and a display communicably connected to the computer system, the display having one or more LED light sources; wherein each pressurized fluid tank is configured, through its attached computer system, to: retrieve and process pressurize fluid data from one or more digital sensors to determine current pressurized fluid data of the pressurize fluid inside the pressurized fluid tank; and illuminate the display according to the determined pressurized fluid data, wherein the central server is configured to illuminate a central server display according to the pressurized fluid data for each pressurized fluid tank in the network.

In an additional or alternative configuration, the central server can be configured to retrieve pressurized fluid data from each of the pressurized fluid tanks at a fixed interval. In an additional or alternative configuration, the central server can be configured to display the pressurized fluid data for each pressurized fluid tank in the network. In an additional or alternative configuration, the central server can be configured such that: when the pressurized fluid data for an individual pressurized fluid tank in the network indicates a warning level, the central server display is illuminated a first color for that tank, and when the pressurized fluid data for that individual pressurized fluid tank in the network indicates another warning level, the central server display is illuminated a second color for that tank that is different from the first color. In an additional or alternative configuration, the central server maintains a database of pressurized fluid data that is associated with each pressurized fluid tank in the network.

Still further configurations include a computer-implemented method for maintaining a real-time display of pressurized fluid data of pressurized fluid inside a pressurized fluid tank, comprising: retrieving pressurized fluid data of the pressurized fluid from one or more digital sensors communicably coupled with a pressured tank; processing the retrieved pressurized fluid data to determine a first color that is associated with the retrieved pressurized fluid data; displaying on a digital display attached to the pressurized fluid tank the determined first color, and a time value representing a first amount of time left before the pressurized fluid is depleted; and upon receipt of a change in pressurized fluid data, displaying on the digital display a second color that is different from the first color, and a second amount of time left that is different from the first time displayed.

In an additional or alternative configuration, the method can include adjusting a single LED to display either the determined first or second colors. In an additional or alternative configuration, the method can include adjusting a plurality of LEDs to display the pressurized fluid data. In an additional or alternative configuration, the method further comprises: communicating with a database; wherein the database is used to store both the retrieved pressurized data and the processed form thereof. In an additional or alternative configuration, the method further comprises: sending the retrieved pressurized data to a central server; wherein the central server (i) processes the retrieved pressurized data, (ii) performs the determination of color, and (iii) passes the determination of color to a database. In an additional or alternative configuration, the method can further comprise: receiving pressurized fluid data for each of a plurality of pressurized fluid tanks in a fleet of pressurized fluid tanks, the pressurized fluid data corresponding to each of one or more pressurized fluid tank monitoring devices; processing the received pressurized fluid data for each pressurized fluid tank to determine a warning level for each pressurized fluid tank; identifying one or more pressurized fluid tanks from the plurality of pressurized fluid tanks based on the determination of warning level; providing rendering instructions for an alert to be displayed on a digital display, wherein the alert indicates a need for maintenance on the identified one or more pressurized fluid tanks.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

1. A pressurized fluid tank monitoring device, comprising:
a pressurized fluid tank;
a computer system communicably attached to the pressurized fluid tank, having (i) a processing module; (ii) one or more digital sensors; and (iii) one or more managing components; and
a display communicably connected to the computer system, the display having one or more LED light sources;
wherein the computer system is configured to:
retrieve (i) pressurized fluid data from the one or more digital sensors associated with pressurized fluid inside the pressurized fluid tank and (ii) environmental data associated with one or more environmental conditions outside of the pressurized fluid tank;
perform processing using as inputs (i) the pressurized fluid data and (ii) the environmental data associated with the one or more environmental conditions outside of the pressurized fluid tank to determine a time remaining in which the pressurized fluid inside the pressurized fluid tank will satisfy one or more conditions and a color associated with the time remaining; and
illuminate the display according to the color associated with the determined time remaining in which the pressurized fluid inside the pressurized fluid tank will satisfy the one or more conditions.

2. The pressurized fluid tank monitoring device as recited in claim 1, wherein the display comprises a plurality of LEDs.

3. The pressurized fluid tank monitoring device as recited in claim 1, the display being configured such that:
when the pressurized fluid data indicates a first warning level, the display is illuminated a first color, and
when the pressurized fluid data indicates a different warning level, the display is illuminated a color that is different than the first color.

4. The pressurized fluid tank monitoring device as recited in claim 1, the display being configured to show the pressurized fluid data, and a numerical value representing an amount of time left before depletion.

5. The pressurized fluid tank monitoring device as recited in claim 1, wherein the pressurized fluid tank is a scuba tank.

6. The pressurized fluid tank monitoring device as recited in claim 1, wherein the pressurized fluid tank is a medical oxygen tank.

7. The pressurized fluid tank monitoring device as recited in claim 1, wherein the pressurized fluid tank is a firefighter's oxygen tank.

8. The pressurized fluid tank monitoring device as recited in claim 1, wherein the computer system is further configured to:
before processing the retrieved pressurized fluid data, store unprocessed pressurized fluid data in a database; and
after processing the retrieved pressurized fluid data, store the processed pressurized fluid data in a database.

9. The pressurized fluid tank monitoring device as recited in claim 1, wherein the computer system is further configured to:
before processing the retrieved pressurized fluid data, send unprocessed pressurized fluid data over a network to a central server; and
after processing the retrieved pressurized fluid data, send the processed pressurized fluid data over a network to a central server.

10. A system, comprising:
a central server communicably connected over a network to one or more pressurized fluid tanks, wherein each pressurized fluid tank of the one or more pressurized fluid tanks comprises:
a computer system communicably attached to its corresponding pressurized fluid tank of the one or more pressurized fluid tanks, the computer system having (i) a processing module; (ii) one or more digital sensors; and (iii) and a managing component; and
a display communicably connected to the computer system, the display having one or more LED light sources;
wherein each particular pressurized fluid tank of the one or more pressurized fluid tanks is configured, through its attached computer system, to:
retrieve (i) pressurized fluid data from one or more digital sensors associated with pressurized fluid inside the particular pressurized fluid tank and (ii) environmental data associated with one or more environmental conditions outside of the particular pressurized fluid tank;
perform processing using as inputs (i) the pressurized fluid data and (ii) the environmental data associated with the one or more environmental conditions outside of the particular pressurized fluid tank to determine a time remaining in which the pressurized fluid inside the particular pressurized fluid tank will satisfy one or more conditions and a color associated with the time remaining; and
illuminate the display according to the color associated with the determined time remaining in which the pressurized fluid inside the particular pressurized fluid tank will satisfy the one or more conditions,
wherein the central server is configured to illuminate a central server display according to the time remaining for each pressurized fluid tank of the one or more pressurized fluid tanks in the network.

11. The system as recited in claim 10, wherein the central server is further configured to retrieve pressurized fluid data from each pressurized fluid tank of the one or more pressurized fluid tanks at a time interval.

12. The system as recited in claim 11, wherein the time interval for each particular pressurized fluid tank of the one or more pressurized fluid tanks is selectively updateable based on the environmental data associated with the particular pressurized fluid tank of the one or more pressurized fluid tanks in the network.

13. The system as recited in claim 10, wherein:
when the pressurized fluid data for an individual pressurized fluid tank of the one or more pressurized fluid tanks in the network indicates a warning level, the central server display is illuminated a first color for the individual pressurized fluid tank, and
when the pressurized fluid data for the individual pressurized fluid tank in the network indicates another warning level, the central server display is illuminated a second color for the individual pressurized fluid tank that is different from the first color.

14. The system as recited in claim 10, the central server is further configured to maintain a database of pressurized fluid data that is associated with each pressurized fluid tank of the one or more pressurized fluid tanks in the network.

15. A computer-implemented method, comprising:
retrieving digital pressurized fluid data of pressurized fluid from one or more digital sensors communicably coupled with a pressurized fluid tank;
processing the retrieved digital pressurized fluid data and environmental data associated with one or more environmental conditions outside of the pressurized fluid tank using one or more processing modules to determine (i) a time remaining in which the pressurized fluid within the pressurized fluid tank will satisfy one or more conditions and (ii) a first color that is associated with the time remaining;
executing computer-executable instructions for displaying on a digital display attached to the pressurized fluid tank the determined first color; and
upon receipt of updated digital pressurized fluid data via the one or more digital sensors indicating an updated time remaining in which the pressurized fluid within the pressurized fluid tank will satisfy the one or more conditions, executing computer-executable instructions for displaying on the digital display a second color that is different from the first color and that is associated with the updated time remaining.

16. The computer-implemented method as recited in claim 15, further comprising selectively adjusting a single LED to display either the determined first color or, alternatively, the second color.

17. The computer-implemented method as recited in claim 15, further comprising adjusting a plurality of LEDs to display the retrieved digital pressurized fluid data or the updated digital pressurized fluid data.

18. The computer-implemented method as recited in claim 15, further comprising:
communicating with a database;
wherein the database is used to store both the retrieved digital pressurized data and a processed form thereof.

19. The computer-implemented method as recited in claim 15, further comprising:
sending the retrieved digital pressurized data to a central server;
wherein the central server (i) processes the retrieved digital pressurized data, (ii) performs the determination of color, and (iii) passes the determination of color to a database.

20. The computer-implemented method as recited in claim 15, further comprising:
receiving digital pressurized fluid data for each of a plurality of pressurized fluid tanks in a fleet of pressurized fluid tanks, the digital pressurized fluid data for each of the plurality of pressurized fluid tanks corresponding to each of one or more pressurized fluid tank monitoring devices;
processing the received digital pressurized fluid data for each of the plurality of pressurized fluid tanks to determine a warning level for each of the plurality of pressurized fluid tanks;
identifying one or more pressurized fluid tanks from the plurality of pressurized fluid tanks based on the determination of warning level; and
providing rendering instructions for an alert to be displayed on a digital display associated with the identified one or more pressurized fluid tanks, wherein the alert indicates a need for maintenance on the identified one or more pressurized fluid tanks.
